(19) United States
(12) Patent Application Publication
(10) Pub. No.: US 2011/0141491 A1
(43) Pub. Date: Jun. 16, 2011

(54) AUTOMATIC HIGH-PRECISION REGISTRATION CORRECTION SYSTEM WITH LOW RESOLUTION IMAGING

(76) Inventors: Chung-Hui Kuo, Fairport, NY (US); Gregory Rombola, Spencerport, NY (US)

(21) Appl. No.: 12/635,040

(22) Filed: Dec. 10, 2009

(51) Int. Cl. G06K 15/02

(52) U.S. Cl. 358/1.2; 358/1.6; 358/1.16; 358/1.9; 358/504

(57) ABSTRACT

System and apparatus for automatically correcting alignment of printer writers using a scanner for calculating a calibration parameter. The calibration parameter is used to adjust or maintain the alignment of the printer writers.

### CROSS REFERENCE TO RELATED APPLICATIONS

Reference is made to commonly assigned, co-pending U.S. patent application Ser. No. ______ by Chung-Hui Kuo et al. (Docket 95959) filed of even date herewith entitled “AUTOMATIC HIGH-PRECISION REGISTRATION CORRECTION METHOD VIA LOW RESOLUTION IMAGING”, the disclosure of which is incorporated herein by reference in their entireties.

### FIELD OF THE INVENTION

The present invention relates to automatic calibration of a printer based on a digital image of the printer's output. In particular, a distance between fiduciary marks and test marks printed by the printer, as captured by an imaging device, such as a scanner, are used to calibrate writer adjustments.

### BACKGROUND OF THE INVENTION

Alignment of color components in a color printer is critical to providing clear accurate prints of color images. Typically, manual visual inspection of printed documents is performed and individual fine tuning of the color component devices in the printer is undertaken until the visual inspection proves acceptable. What is needed is an automatic and inexpensive way to accurately adjust the color component devices in a color printer.

### SUMMARY OF THE INVENTION

One preferred embodiment of the invention includes a printing system that includes a printer and an imaging device, such as a scanner. A memory of the system includes a stored calibration target image, preferably in a bitmap format. The calibration target includes print data designating different colors for testing alignment of the color stations. The printer prints the calibration target with the plurality of fiduciary marks on a print medium, together with the color test marks. An imager captures a digital image of the print medium and, optionally, stores a digital image version of the print medium having the marks printed thereon. A calibrator in the scanner is used to determine a distance between at least two of the marks in the digital image. The distance is compared with another known distance such as a known hardware dimension of the printer, if the fiduciary marks are being calibrated, or the distance is compared with a known good distance if color test marks are being calibrated. A resultant calibration adjustment value can then be determined for aligning color writers in the printer. The processing system of the printing system can calculate adjustment magnitudes in a variety of formats, such as direct distance adjustments, number of pixels, relative position, or any other programmable format.

Another preferred embodiment of the present invention includes a printing and scanning system comprising a printer for printing digital images. The printer includes memory for storing a calibration target image for printing and the calibration target image includes test marks having a known separation distance.

An imaging device such as a scanner or a camera captures a digital version of the printed calibration target image for measuring a distance between the test marks on the printed calibration target and for determining a correction factor based on the known separation distance and on the distance between the test marks on the printed calibration target.

Another preferred embodiment of the present invention includes an apparatus comprising an imaging system for capturing a digital version of a printed image and for measuring a distance between selected print data in the digital version of the printed image. A computation such as a calculator determines a difference of the distance between selected print data in the digital version of the printed image and a distance between selected image data in a digital calibration target image, and for calculating a correction factor based on the difference. The selected print data can comprise a plurality of different colors and fiduciary data for calculating a scaling factor for the selected print data, including scaling data for the plurality of different colors. The measured distances and their differences can be represented in the form of a matrix whose size is determined by an amount of the selected print data. A conveniently preselected known matrix can then be combined in an equation involving the distances matrix to calculate a correction factor. The more color data there is in the printed image the large is the preselected known matrix

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. For example, the summary descriptions above are not meant to describe individual separate embodiments whose elements are not interchangeable. In fact, many of the elements described as related to a particular embodiment can be used in, and possibly interchanged with, other described embodiments. Many changes and modifications may be made within the scope of the present invention without departing from the spirit thereof, and the invention includes all such modifications. The figures below are not intended to be drawn to any precise scale with respect to size, angular relationship, or relative position.

### BRIEF DESCRIPTION OF THE DRAWINGS

FIG. 1 illustrates a flow chart of a method of the present invention.

FIG. 2 illustrates fiduciary marks and test marks printed on a print medium by an unadjusted printer.

FIG. 3 illustrates fiduciary marks and test marks printed on a print medium by an adjusted printer.

FIG. 4 illustrates detected fiduciary marks and test marks as recorded by a 300 dpi scanner.

FIG. 5 illustrates an enlarged version of the detected fiduciary marks and test marks of FIG. 4.

FIG. 6 illustrates calculations performed using the measured distances of the printed output.

FIG. 7 illustrates example linear matrix equations for calculating adjustment parameters.

FIG. 8 illustrates an example five color station electrographic printer.

### DETAILED DESCRIPTION OF THE INVENTION

The invention has been described in detail with particular reference to certain preferred embodiments thereof, but it will be understood that variations and modifications can be effected within the spirit and scope of the invention.

An embodiment of the present invention is intended to automatically estimate the cross-track (lateral) positional relationship among all color channels of a printer in high precision. The print media is augmented with suitably separated marks of two different colors, where the pre-defined separation distance between a pair of selected color marks is chosen to balance between the need for high precision location estimation and wide applicable range. The distance between the two color marks will determine the range of allowable registration correction. The alignment process of one embodiment of the present invention adopts a series of line marks generated by a print head as local fiduciary marks to achieve accurate alignment despite potentially large scanner motion variation. For example, if scanning resolution is 300 dpi with the scanning speed varying up to 8 pixels, while the requirement for cross-track registration is 0.5 pixel in 600 dpi printing resolution, which is equivalent to 1200 dpi in precision, simply measuring the distance is insufficient to provide useful positional information among different color channels to automatically correct lateral registration error.

In one preferred embodiment, the calibration target contains all possible pair-wise combination such as cyan_vs_black, magenta_vs_yellow, etc. at various locations across the entire cross-track. These pair wise combinations can include all combinations in a four, five, or six color system. While all possible pair-wise combinations provides the most data for precise alignment, the present invention can be used with less print data, such as a calibration target print using one of the color stations as primary. As a result, the optimized cross-track registration offset among all color channels as well as the lateral magnification factor can be reliably estimated through solving a set of linear equation. The same technique can be easily extended to in-track registration correction.

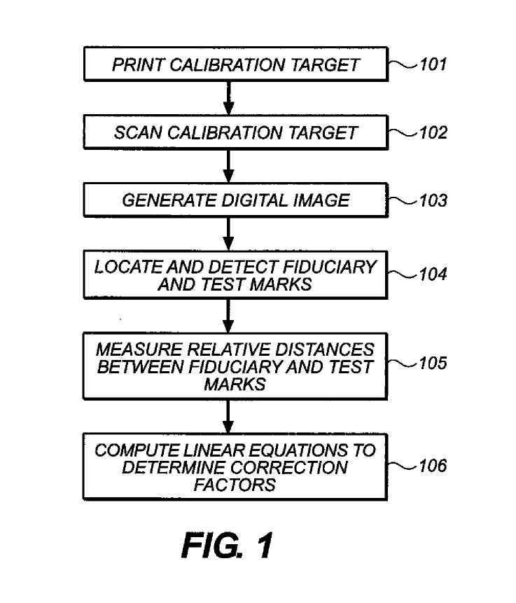

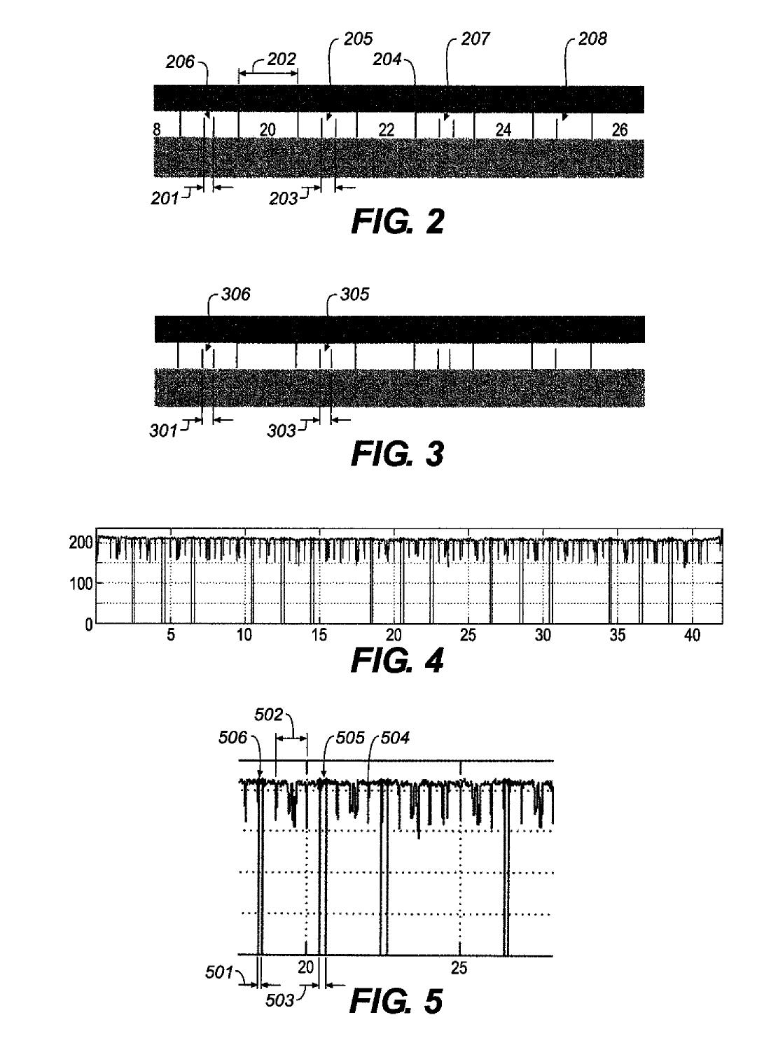

Referring to FIG. 1, a flow chart of the present invention is illustrated. At step 101, a prestored calibration target image is printed by the printer to be calibrated. A portion of the calibrated target image is shown in FIGS. 2 and 3. As mentioned above, the calibration target can be selected to span the entire cross-track. This means that the image of the calibration marks shown in FIGS. 2-3 are printed while the medium travels through the printer in a vertical direction. An adjustment of a color station in the printer will result in a left-right (horizontal) movement of a test mark shown in FIGS. 2-3, as viewed on the page. Typically, a high precision printer will include an electronic touchpad or other input device for entering a correction magnitude. The corresponding color station will be precisely adjusted, i.e. moved left or right, according to the input amount, orthogonally across the print medium travel path. A calibration target image can contain any number of marks. The colors of the marks can be selectively designated for a variety of testing combinations. The calibration target whose portion is shown in FIG. 2 contains approximately fifteen pairs of effective calibration test marks, for a four color printer. A five color printer can include, for example, twenty effective test marks (twenty pairs). The number of test marks generated for printer correction depends on whether an ideal set of all pair-wise color combinations will be utilized for determining calibration parameters. As mentioned previously, not all pair wise combinations are necessary to properly implement the present invention. However, the more color pair data that is generated, the more precise will be the resulting calibration parameters.

The calibration target image can be stored in a variety of formats, such as TIFF, PDF, a bitmap, or other formats. The fiduciary marks 204 are separated by a known distance 202, and appear on both sides of the numerals 20, 22, etc, which comprise numbering of the fiduciary marks. These marks are determined by a manufactured physical parameter of the print head which is fabricated to exact tolerances. These tolerances may be the result of silicon fabrication for particular print head technologies, however, the point is that these distances are determined by print head geometry and are not alterable after manufacture. The stored calibration target image is created as a bitmap such that the fiduciary and test marks are placed in precisely known positions in the bit map so that when the image is loaded to be printed, the pixels will be directed to predetermined LED positions in the writer, as an example. The test mark pairs 205, 206, 207, 208 consist of pairs of color test marks printed by corresponding color writers in the printer. Color pair 206 includes a black line and a cyan line, color pair 205 includes a black line and a magenta line, color pair 207 includes a black line and a yellow line, and the space designated as 208 includes a single black line with a reserved space for a fifth color. This is because the calibration target image is useable for a five color printer. However, the calibration target shown in FIGS. 2-3 was printed on a four color printer, therefore, every fourth target pair will contain a missing fifth color. This example calibration target image uses black as primary which is paired with each color as exemplified above (the fiduciary marks 204 are also printed black when black is primary as in this example). The sequence of color pairs is repeated five times spanning the entire cross track and the measured distances are averaged for each color pair on the printed calibration target. Three additional calibration target images can be printed using each of the other colors as primary, and all four print media then can be used to calculate calibration parameters for this printer, however, only one printed calibration target can be implemented successfully using the methods of the present invention. Moreover, the color pair combinations need not be repeated, and measurements averaged, so as to span the entire cross-track in order to implement the present invention. For the example test calibration target image shown in FIG. 2, the distances 201, 203, etc., between the test marks 206, 205 should be equivalent, because the stored calibration target image data defines these as equivalently spaced, however, they are not. Thus, these print data indicate that the printer can be improved with an automatically calibrated realignment.

Step 102 of the flowchart of FIG. 1 indicates that the printed calibration target image is scanned using a typical 300 dpi scanner, although the scanner used for this step can be designed for other resolutions. An imaging device other than a scanner can also be used, such as a camera. The next step 103, after imaging the calibration target, results in generating at least one storable digital image of the printed calibration target image. If all primary color stations are used for printing the calibration target, then four primary calibration target images will be scanned. Step 104 includes locating and measuring the fiduciary distances 202 and test mark distances 201, 203 across the entire width of the print media. Because the calibration target image is a known prestored image, the scanner can be easily directed to the location where the fiduciary marks and test marks are located in the scanned digital image.

FIG. 4 illustrates an output of a scanner that has traversed the printed calibration target and detected the fiduciary marks and test marks illustrated in FIGS. 2-3. The horizontal line at 200 indicates a baseline detection of a white print medium. The detected printed fiduciary marks are indicated in the scanner output of FIG. 4 as numbered detection peaks 5, 10, 15, etc., where every fifth fiduciary detection peak is numbered. FIG. 5 shows an enlarged portion of the scanner output of FIG. 4. With reference to FIG. 5, the test marks detection peaks are vertically extended, and test marks pair 206 is illustrated in the scanner output as shown by the pair of lines 506 and the test mark pair 205 is represented in the scanner output by the pair of lines 505. The fiduciary mark 204 is illustrated by the peak 504, and the distances 201 and 203 are represented by 501 and 503. The data provided by these scanner detected fiduciary and test marks can be used to measure pixel distances between them, which is the next step of the flow chart 105.

Relying upon the measured distance between pairs of fiduciary marks in the scanned image and comparing those measured values to the known manufactured reference distance, a corrective scaling factor can be applied to the measured test mark distances in the scanned image, if necessary. Because each pair of test marks is proximate to a pair of fiduciary marks, the fiduciary marks likely are subject to the same scanner inaccuracies as the proximate test mark pair, so the scaling factor can be correctly assumed to be applicable to the measured distance between test marks proximate to the measure fiduciary marks. If the measured distance between fiduciary marks is exactly as it should be (according to manufacturer tolerances), then there is no need for correcting the measured distance between corresponding proximate test marks. After the test marks distances are measured, scaled if necessary, and averaged if necessary, they are stored for computation purposes of the present invention as explained below. All of the measurement data mentioned herein, including the calibration target image actual distances, are stored digitally for access by the scanner or other digital electronic computation device, such as a calculator. For reference purposes as to the practice of the present invention, it should be noted that the printed calibration target illustrated in FIGS. 2 and 3 is a result of the print medium moving vertically (top to bottom of page) through the color printer, while the print medium travels through the scanner in a horizontal (left-right of page) direction.

As explained previously, a more precise method of the present invention involves printing four sets of calibration target images using each of the four color writers as primary imaging sources. In this manner the distances between pairs of color test marks generated by each of the printed calibration targets are averaged. However, as explained previously, the present invention can be used with only one test calibration target print.

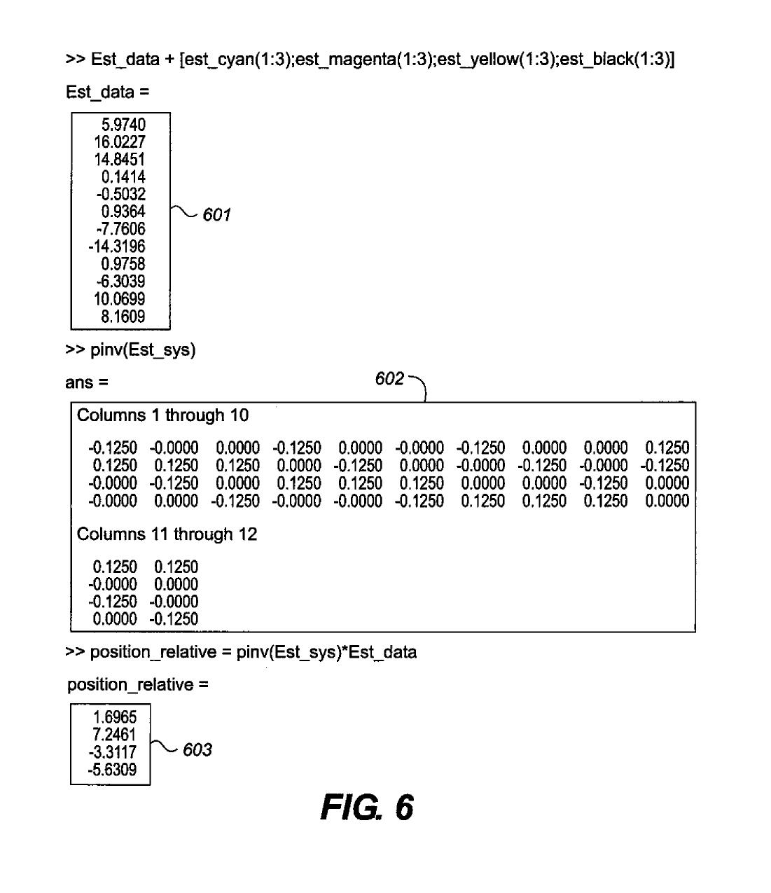

With reference to FIG. 6, there is shown an output 601 of the measurements of each of the test mark color pairs. Each pair of color test marks has associated therewith a known good distance (measured in pixels) and the output shown at 601 represents a deviation from the known good distance. They are indicated as positive and negative deviations which correspond to adjusting a particular color station in a left or right direction. There are twelve results shown at 601 and they represent measured distance deviations as follows, in sequence from top down, KC, KM, KY, CK, CM, CY, MK, MC, MY, YK, YC, YM, where C, M, Y, K, refer to colors Cyan, Magenta, Yellow, Black, respectively, as is well known. These results are generated from scanning four print media having printed thereon the calibration target image, one for each of the color stations used as primary. The first group of three measurements corresponds to the black primary calibration target, the send group of three corresponds to a cyan primary calibration target, and so on. A five color printer would generate a column of twenty measured results if the same procedure is used as in this present example. These color pairs represent the same sequence of effective color pairs 206, 205, 207, as they appear on the printed and scanned calibration target image whose portion is shown in FIGS. 2-3.

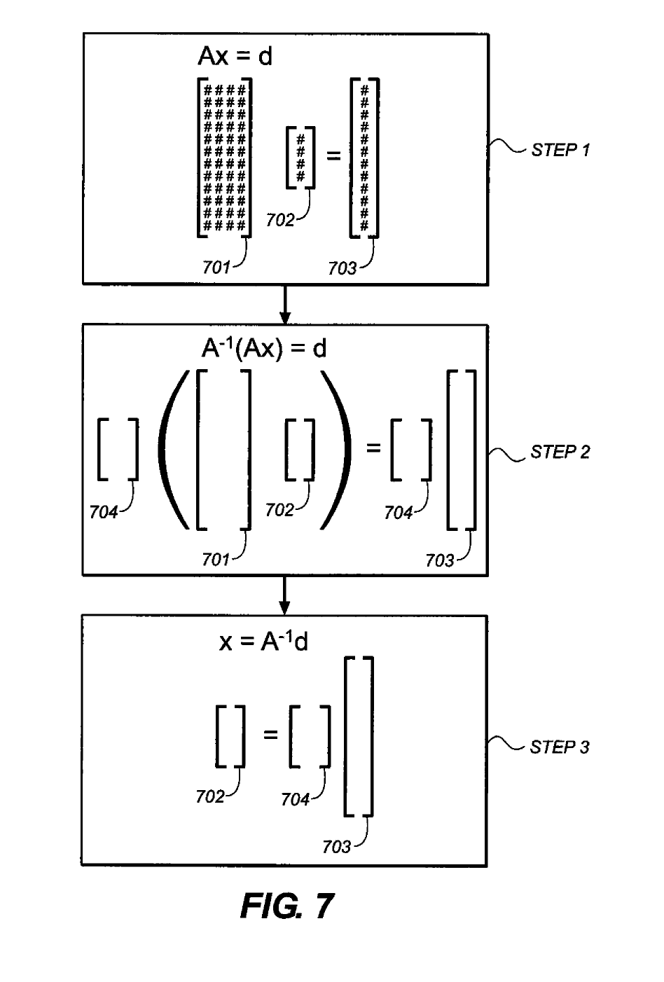

The last step of the flow chart shown in FIG. 1 is the step 106 of computing linear matrix equations to determine the correction factors for adjusting and fine tuning the lateral positions of the color writers of the printer that is to be calibrated. FIG. 7 represents calculations applied to the measurements derived from the printer, and shown in FIG. 6, to determine magnitudes of lateral corrections necessary to align the color writers of the printer. The measurements output 601, previously described, represents a 12×1 matrix represented in FIG. 7 as “d” for actual distances in the equation Ax=d, and as the 12×1 matrix 703. A preselected, known 12×4 matrix is shown at 602 and is used in combination with the measured results 601 to extract the (unknown) correction parameters. The preselected 12×4 matrix is represented in FIG. 7 as “A” in the equation Ax=d, and by the 12×4 matrix 701. The unknown correction parameters are represented in FIG. 7 as “x” in the equation Ax=d, and by the 4×1 matrix 702. The unknown correction parameters can be obtained because the actual measurements have been obtained 601, and the preselected 12×4 matrix 701 is also known. FIG. 7 illustrates the mathematical reasoning behind the resolution of this linear matrix equation.

With reference to FIG. 7, step 1, Ax=d represents the relationship between the measured distances between the color pairs of test marks, d 703, and the correction values that are needed for fine tuning the color writers, x 702. “A” 701 represents the 4×12 matrix shown at 602, while d is the 12×1 matrix 703 of measured distances shown at 601, and x is a 4×1 matrix 702 of desired corrective values 603. By multiplying both sides of the equation with an inverse matrix A⁻¹ 704 of the known matrix 602 at step 2, we can determine, at step 3, that x is equal to the known measured distance matrix of color pair test marks 703 (shown as 601 in FIG. 6) multiplied by the known inverse matrix 704 (inverse of matrix A shown at 602). Therefore, x is the 4×1 resulting matrix 702 whose results are shown at 603, using the values as explained above. The output at 603 represents, in top-down sequence, a corrective distance measured in pixels for each of color writers K, C, M, Y. In implementing this corrective information, any of the color writers can be selected to remain as the stationary reference writer even though each of them corresponds to a corrective value output at 603. After selecting one of the writers as the stationary writer, the difference in relative corrective distance for each color writer, as compared to the selected stationary writer, is applied to the corresponding writer. The result of the corrective adjustment is illustrated in FIG. 3 where distances 301 and 303, corresponding to previously misaligned distances 201 and 203 of FIG. 2, between color tests marks are equal to each other and equal to the known good distance.

As explained previously, the present invention can be applied to a single scanned print medium having the calibration target image printed thereon using a single primary color. It can also be applied if two or three pages of the calibration target image were printed, one for each of a selected primary color station. For the example of a single scanned print medium having the calibration target printed thereon, if the selected primary color is black, for example, then the output at 601 would include only the first three measurements (KC, KM, KY) and would result in a 3×1 matrix for computation purposes. If two or three primary color sheets are printed, for example cyan as a second, and magenta as a third, then an additional three colors for each would be included in the output at 601-CK, CM, CY, and MK, MC, MY, respectively. Continuing with the single color example, the preselected known matrix “A” would include the first three columns of 602, for example, a 4×3 matrix (and if the second and/or third color measurements are added then the known matrix would expand to 4×6 and 4×9, respectively). The equations would proceed with the same rationale as illustrated in FIG. 7, and would result in an equivalent 4×1 solution matrix at 603. It can be easily and simply extrapolated, based on the foregoing detailed explanation, that the present invention can also be applied to a five color printer providing five primary color calibration targets whose scanner output would then provide twenty measurements.

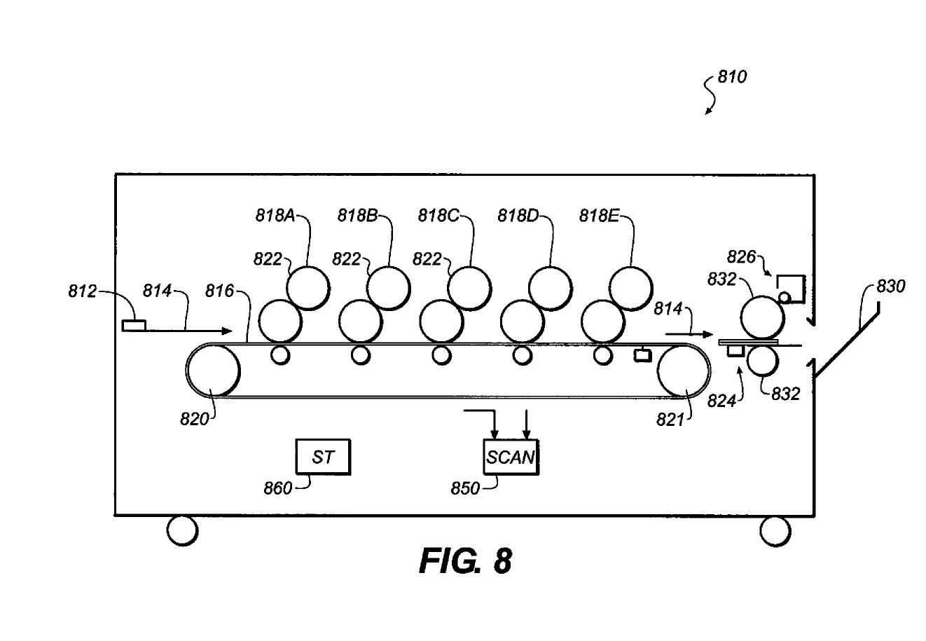

Referring now to FIG. 8, there is illustrated a side elevation view of a reproduction apparatus such as a well known digital printer 810. The digital printer includes print media or receiver sheet 812 in operative association with a print media transport path 814. Digital storage 860 stores print image data that is formatted for printing on the receiver sheet. In order to accomplish desired printing, individual media sheets are fed along belt 816 seriatim from selected receiver sheet supplies for transport along the receiver sheet transport path 814 through a plurality of imaging stations 818A, 818B, 8180, 818D, and 818E, which can each be, in any sequence, a black, cyan, magenta, yellow, and fifth color station (e.g. red, green, or blue), by a moving belt sheet transport mechanism, rollers 820 and 821, under motor control (not shown), where color separation images are transferred to the respective print media, such as by any well known electrographic reproduction method. In such electrographic reproduction method, in each color imaging station 818A-818E, an electrostatic latent image is formed on a primary image-forming member 822 such as a dielectric surface and is developed with a thermoplastic toner powder to form a visible image. The visible thermoplastic toner powder images are thereafter transferred in superimposed register to a print medium. The combined visible thermoplastic toner powder image on the receiver sheet is transported by a second moving belt transport mechanism 824 through a fusing station 826, and fused to the print media by the fusing station 824 using heat or pressure, or both heat and pressure. The fusing station 824 can include rollers 832, belt, or any surface having a suitable shape for fixing thermoplastic toner powder to the receiver sheet. The receiver sheet transport comprises a continuous belt 816 entrained about two rollers 820, 821 to provide a closed loop path for the belt 816. The rollers are supported by a frame (not shown). The fusing station rollers 832 moves the final printed medium having the thermoplastic toner fixed thereon through an opening of the digital printer 810 onto an output tray 830 for stacking printed media. A scanner 850 is operatively coupled to printer 810 and can be constructed as an integrated scanner or scanner 850 can be a standalone scanner. A printed calibration target from the printer can be designed to be automatically fed to the scanner for scanning or, alternatively, the printed calibration target can be manually retrieved from the output tray 830 and placed in the scanner for obtaining the digital image of the printed calibration target. The scanner is programmed according to the flowchart of FIG. 2 and its output can be coupled to the printer 810 for alignment of corresponding color stations 818A-818E. The output of a standalone scanner can be used for manually inputting correction factors on printer 810 for aligning each color station.

The invention has been described in detail with particular reference to certain preferred embodiments thereof, but it will be understood that variations and modifications can be effected within the spirit and scope of the invention.

1. A printing system comprising:
a printer for printing a plurality of marks on a print medium;
an imager for imaging the print medium, and an image memory for storing a digital image of the print medium having the marks printed thereon;
a measurement system for determining a distance between at least two of the marks in the digital image;
a comparator for comparing the distance between at least two of the marks with a known distance; and
a processor for determining a calibration adjustment for aligning writers in the printer.

2. The system of claim 1, wherein the writers each apply a different color to the print medium.

3. The system of claim 2, wherein said at least two of the marks are each of a different color.

4. The system of claim 2, wherein said printer is for printing a second plurality of marks on the print medium, the second plurality of marks comprising a plurality of fiduciary marks for scaling, if necessary, the determined distance between said at least two of the marks as determined by the measurement system.

5. The system of claim 1 wherein said plurality of marks comprises a plurality of pairs of marks, each of the pairs of marks comprising a first mark having a first color and a second mark having a different color, and wherein said distance between said at least two of the marks is used to calculate the calibration adjustment for a corresponding writer that printed one of said at least two of the marks.

6. The system of claim 5 wherein a plurality of media are printed and imaged for the measurement system to determine the distance between said at least two of the marks in the digital image

7. A printing and scanning system comprising:
a printer for printing digital images, the printer including memory for storing a calibration target image for printing, the calibration target image including test marks having a known separation distance; and
an imaging device for capturing a digital version of the printed calibration target image, for measuring a distance between the test marks on the printed calibration target, and for determining a correction factor based on the known separation distance and on the distance between the test marks on the printed calibration target.

8. The system of claim 7 wherein the imaging device is selected from the group consisting of a camera and a scanner.

9. The system of claim 7 wherein the printer includes a plurality of color stations for printing a color image of the calibration target.

10. The system of claim 9, wherein the printer further comprises an adjustment mechanism for adjusting an orientation of the color station based on the correction factor.

11. The system of claim 7, wherein the calibration target image includes fiduciary marks having a fiduciary distance therebetween for comparing with the distance between the test marks on the printed calibration target for determining a scaling factor of the distance between the test marks on the printed calibration target.

12. An apparatus comprising:
an imaging system for capturing a digital version of a printed image and for measuring a distance between selected print data in the digital version of the printed image; and
a computation device for determining a difference of the distance between selected print data in the digital version of the printed image and a distance between selected image data in a digital calibration target image, and for calculating a correction factor based on the difference.

13. The apparatus of claim 12, wherein the selected print data comprises color data of a plurality of different colors.

14. The apparatus of claim 12 wherein the print data includes fiduciary data for calculating a scaling factor for the selected print data.

15. The apparatus of claim 13 wherein the correction factor includes correction data for the plurality of different colors.

16. The apparatus of claim 15 wherein the difference of the distance between selected print data in the digital version of the printed image is generated in the form of an M×1 matrix, where M is determined by an amount of the selected print data.

17. The apparatus of claim 16 wherein a preselected known C×M matrix is combined with the M×1 matrix to calculate the correction factor, where C is a number of the plurality of different colors.
